(19) United States
(12) Patent Application Publication
(10) Pub. No.: US 2004/0088914 A1
(43) Pub. Date: May 13, 2004

(54) Frost cover

(76) Inventor: Joel R. Warner, Englewood, FL (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/634,382

(22) Filed: Aug. 5, 2003

Related U.S. Application Data
(60) Provisional application No. 60/401,085, filed on Aug. 5, 2002.

(51) Int. Cl. A01G 13/02

(52) U.S. Cl. 47/20.1

(57) ABSTRACT

A method and apparatus for covering vegetation in a cold or windy environment such that the vegetation is protected from frost. The cover includes a sheet of material that has a parameter edge. The parameter edge is folded to form piping and a weight is positioned within the piping to restrain the movement of the cover when the cover is in position over the vegetation.

### RELATED APPLICATION

This application claims priority of U.S. Provisional Application Serial No. 60/401,085 filed Aug. 5, 2002 and is incorporated herein by reference.

### BACKGROUND OF THE INVENTION

1. Field of the Invention

The present invention relates to a cover or blanket for agricultural use. More particularly, the invention concerns a blanket or cover having weights integrated therein for use in overlying or covering fauna from the harmful effects of frost.

2. Reference to Related Art

It is known in the art that plants (such as roses) must be covered during cold periods to be protected from the harmful effect of frost. A typical covering will take the form of a blanket or sheet of plastic that is thrown or placed over the plant(s). However, during windy conditions, such simple covers are oftentimes merely blown off the plants(s), thereby exposing the plant(s) to the elements. Therefore, it is often necessary to secure the cover in order to maintain the blanket or cover in position over the plant(s). This usually requires the user to places boards, rocks or other (unsightly and often ineffective) heavy objects on top of the cover.

Blankets and covers having weights integrated around the parameter thereof are known from, for example, U.S. Pat. No. 4,910,855, which discloses a weighted bale blanket, and U.S. Pat. No. 4,634,618, which discloses a weighted towel. However, the prior art does not teach or suggest a weighted blanket or cover for use in connection with agriculture.

By way of example, U.S. Pat. No. 4,250,661 discloses an agricultural covering multi-layer film or sheet structure. The covering includes a film or sheet of thermoplastic resin and a layer of thermoplastic resin that is laminated to at least one surface of the film or sheet. However, this agricultural covering does not include weights for securing the covering in position of the plant(s).

Similarly, U.S. Pat. No. 5,021,285 discusses a non-woven sheet for agricultural use that is made of a hydrophobic fabric material that is subjected to a hydrophilic treatment. However, this covering too does not include an integrated weight system.

### SUMMARY OF THE INVENTION

The present invention concerns a cover for placement of vegetation in cold or windy weather such that the vegetation is protected from frost. The cover includes a sheet of material that has a parameter edge. The parameter edge is folded to form a piping. A weight is positioned within the piping to restrain the movement of the cover when the cover is in position over the vegetation. The cover may be used in connection with a range of vegetation, including residential landscaping plants, commercial landscaping plants, rural crops, residential crops and commercial crops. The sheet for the cover may be constructed of a textile or a synthetic material (e.g., a polymer). If a synthetic material is used, it should include numerous micro-perforations to allow the cover to “breath”.

The sheet may be colored any color or shade and may be colored or coated such that it absorbs or deflects heat. The piping around the edge of the sheet may be continuous about the parameter or staggered. The piping may also be constructed such that it extends into the interior areas of the sheet.

The weight used with the cover can be a flexible weight (e.g., sand, beads or a fluid) or a rod, disc or magnet.

### BRIEF DESCRIPTION OF THE DRAWINGS

A better understanding of the present invention will be had upon reference to the attached figures, wherein like reference numbers refer to like parts throughout, and wherein:

FIG. 1 is an environmental perspective view of a frost blanket constructed in accordance with a preferred embodiment of the present invention and shown in position over vegetation;

FIG. 2 is a perspective, cutaway view of a frost blanket constructed in accordance with the preferred embodiment of the invention;

FIG. 3 is a planar, cutaway view of a frost blanket constructed in accordance with the preferred embodiment shown in the shape of a circle; and

FIG. 4 is a perspective, cutaway view of a frost blanket constructed in accordance with an alternative embodiment of the invention.

### DESCRIPTION OF THE INVENTION

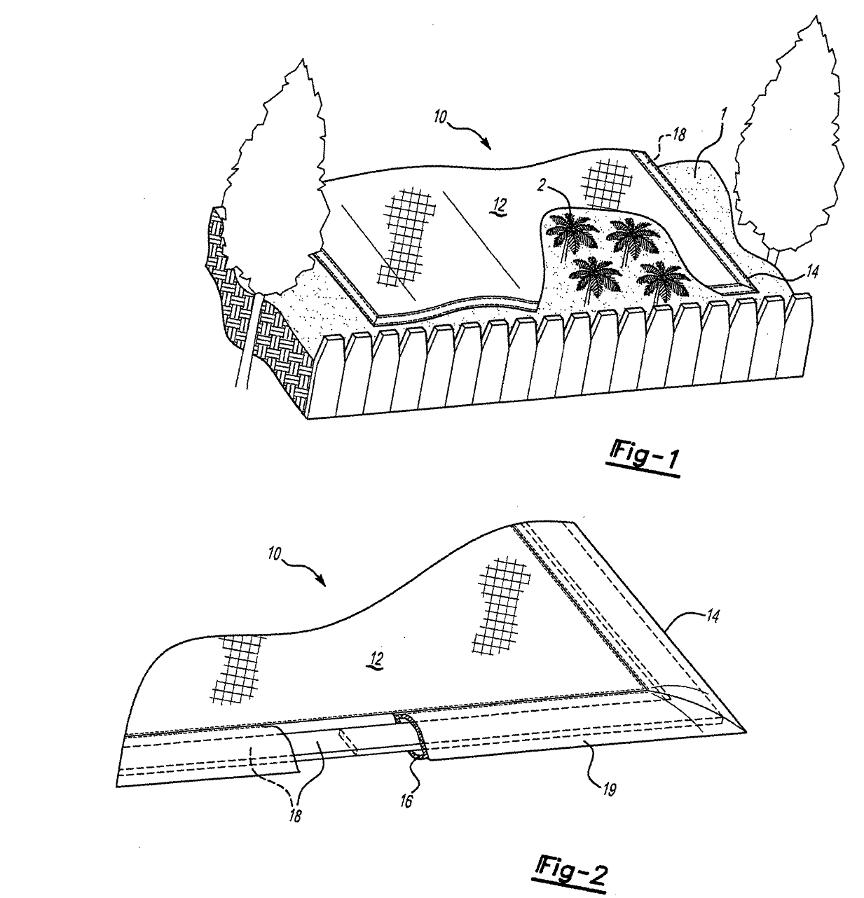

Referring now to FIGS. 1 and 2, there is show a preferred embodiment of a frost blanket 10 constructed in accordance with the present invention overlying an area of earth 1 (i.e. a flower bed) having vegetation 2 (see FIG. 1) grown/growing thereon. The frost blanket 10 includes a sheet of material 12 having folded edge portions 14 that form piping 16. A weight(s) 18 is positioned within the piping 16 and assist in holding the frost blanket 10 in position over the vegetation 2. Notably, while the frost blanket 10 is shown in position over “residential” style landscaping plants (i.e., shrubs, flowering plants, fruit trees, ornamental plants, etc.), it will be appreciated that the frost blanket 10 of the present invention has a wide range of uses, including use in connection with the protection of rural (i.e., farmland), residential and commercial (i.e., experimental) crops, commercial landscaping or the like.

The sheet of material 12 is preferably a textile material. As such, the sheet 12 may be constructed from cotton, wool or any other available fabric or fabric blends (include synthetic fabrics). Alternatively, the sheet 12 may be constructed of a polymeric material (e.g., plastic). Such polymeric materials will preferably have a plurality of micro-perforation that permits the material to “breath” in a manner similar to a natural (or suitable synthetic) textile.

The sheet 12 may be colored any color or combination of colors according to the needs of the user. For example, the sheet 10 may also be colored or coated (using means know in the art) such that it either absorbs (black) or deflects (white) heat. Additionally, the sheet 12 may be colored earth tones (or the like) such that the sheet 12 would blend in with the surrounding terrain or architecture.

The ends or edge portions 14 of the sheet are folded over and sewn together to form a piping 16 that extends around the parameter 19 of the sheet 12. Alternatively, the piping 16 may be staggered (see FIG. 2) such that it extends only around portions of the edge 14 of the sheet 12 (e.g., the piping 16 may intermittently (or irregularly) arrayed along the parameter 19 of the sheet 12.

The weight(s) 18 is positioned within the piping 16. Preferably, the weight(s) 18 is a flexible weight such as sand, metal beads or a fluid (i.e., water) that is encapsulated by the piping 16. If a fluid is used as the weight 18, the fluid may, for example, be stored within bags (or the like) that are dimensioned to fit within the piping 16. Additionally, metal rods, discs or even metal magnets may be used as the weight 18. The weight 18 should be heavy enough to hold the blanket 10 in position over the designated vegetation (see FIG. 1) during windy environment conditions, but light also enough that the blanket 10 does not compress, crush or brake the vegetation it is intended to protect.

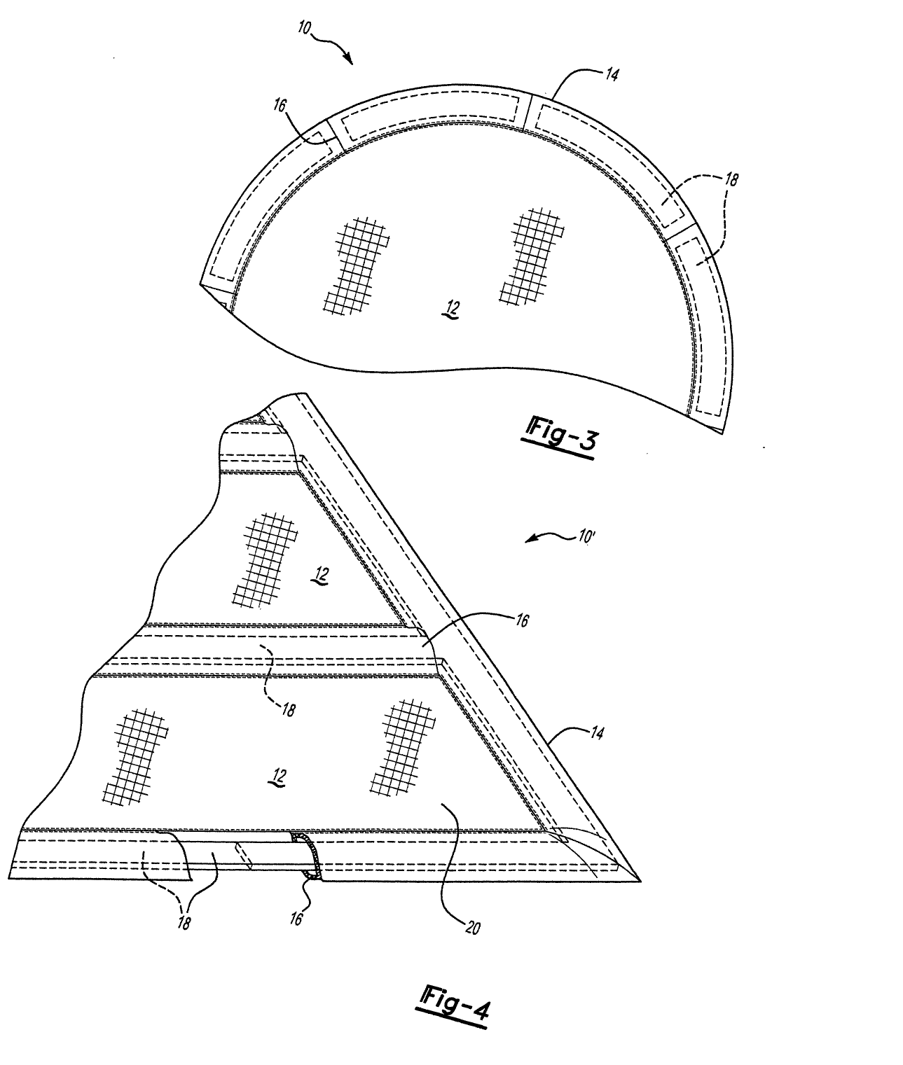

Referring now to FIG. 3, the blanket 10 is constructed from a sheet 12 that has a generally circular pattern having piping 16 and a weight(s) 18 along the parameter 19. Accordingly, it is understood that the blanket 10 may be constructed in a variety of shapes (i.e., square, rectangle, circle, oval, star, trapezoid, parallelogram, etc.) or sizes (i.e., 10′×10′, 10′×100, 25′×150′).

Referring now to FIG. 4, there is shown an alternative embodiment of the frost blanket 100 of the present invention wherein the piping 16 is positioned or extends into the interior area 20 of the sheet 12. A weight(s) 18 is positioned within the piping 16 as a means of securing the sheet 12 over the vegetation (not shown).

Having thus described my invention, various modifications and improvements will become apparent to those having skill the art that do not depart from the spirit of the invention.

I claim:

1. A method for covering vegetation in a cold or windy environment such that the vegetation is protected from frost, comprising the steps of:
providing an area of earth, the area of earth having vegetation disposed therein;
providing a cover for placement over the vegetation, the cover including a sheet of material, the material having a parameter edge, the parameter edge being folded to form piping around the parameter of the sheet, and a weight disposed within the piping; and
positioning the cover over the vegetation, whereby the weight disposed within the piping functions restrain the movement of the cover.

2. The method of claim 1, wherein the vegetation is selected from a group consisting of: residential landscaping plants, commercial landscaping plants, rural crops, residential crops and commercial crops.

3. The method of claim 1, wherein the sheet comprises a textile material.

4. The method of claim 1, wherein the sheet comprises a synthetic material.

5. The method of claim 4, wherein the synthetic material further comprises a polymeric material.

6. The method of claim 4, wherein the synthetic material further comprises a plurality of micro-perforations.

7. The method of claim 1, wherein the sheet is colored black.

8. The method of claim 1, wherein the piping is staggered around the parameter edge of the sheet.

9. The method of claim 1, wherein the weight comprises a flexible weight.

10. The method of claim 9, wherein the flexible weight is selected from the group consisting of: sand, metal beads and a fluid.

11. The method of claim 1, wherein the weight is selected from the group consisting of: a flexible weight, a metal rod, a disc and a magnet.

12. The method of claim 1, wherein the piping extend into an interior area of the sheet.

13. A cover for vegetation for use in cold or windy environments such that the vegetation is protected from frost comprising:
a sheet of synthetic material having a parameter edge and a plurality of micro-perforations, the parameter edge being folded to form piping; and
a weight positioned within the piping to restrain the movement of the cover when the cover is in position over the vegetation.

14. The cover of claim 13, wherein the sheet is colored black.

15. The cover of claim 13, wherein the piping is staggered around the parameter edge of the sheet.

16. The cover of claim 13, wherein the weight comprises a flexible weight.

17. The method of claim 16, wherein the flexible weight is selected from the group consisting of: sand, metal beads and a fluid.

18. The cover of claim 13, wherein the weight is selected from the group consisting of: a flexible weight, a metal rod, a disc and a magnet.

19. The method of claim 13, wherein the piping extend into an interior area of the sheet.

20. The cover of claim 13, wherein the sheet is colored black.
